(19) United States
(12) Patent Application Publication
(10) Pub. No.: US 2025/0167360 A1
(43) Pub. Date: May 22, 2025

(54) Battery Block

(71) Applicant: LG Energy Solution, Ltd., Seoul (KR)

(72) Inventor: Doo Han Yoon, Daejeon (KR)

(73) Assignee: LG Energy Solution, Ltd., Seoul (KR)

(21) Appl. No.: 18/841,001

(22) PCT Filed: Nov. 24, 2023
(86) PCT No.: PCT/KR2023/019080

§ 371 Date: Aug. 23, 2024

(30) Foreign Application Priority Data
Nov. 29, 2022 (KR) 10-2022-0163083

(51) Int. Cl. H01M 50/209; H01M 50/264

(52) U.S. Cl. CPC H01M 50/209; H01M 50/264

(57) ABSTRACT

A battery block includes a cell array having a plurality of prismatic cells arranged in a row surrounded by a pair of side plates disposed on two sides of the cell array, respectively, and a pair of end plates disposed on a front side and a rear side of the cell array, respectively. Both ends of each end plate are fixed against a respective side bracket disposed at both ends of each of the side plates in a length direction. The interconnection of the end plates and the side plates is configured to constrain the cell array into one block.

### CROSS-REFERENCE TO RELATED APPLICATION

This application is a national phase entry under 35 U.S.C. § 371 of International Application No. PCT/KR2023/019080 filed on Nov. 24, 2023, which claims the benefit of priority based on Korean Patent Application No. 10-2022-0163083, filed on Nov. 29, 2022, and the entire contents of the Korean patent application and the International Application are incorporated herein by reference.

### TECHNICAL FIELD

The present disclosure relates to a battery block that can simplify the structure of a battery pack to improve space utilization and reduce production costs and can be easily expanded to various specifications to match the capacity of the battery pack.

### BACKGROUND ART

Unlike primary batteries, secondary batteries can be recharged and have been researched and developed in recent years due to their potential for miniaturization and large capacity. The demand for the secondary battery as an energy source is increasing rapidly due to the technological development and increasing demand for mobile devices, electric vehicles, and energy storage systems, which are emerging in response to the need for environmental protection.

Secondary batteries are categorized into coin batteries, cylindrical batteries, prismatic batteries, and pouch batteries based on the shape of the battery case. In the secondary battery, the electrode assembly mounted inside the battery case is a charging and discharging power generation element consisting of a stacked structure of electrodes and separators.

Secondary batteries are a form of battery pack, where a plurality of battery cells can form one group. Battery packs increase energy density and can be used in devices that require high energy, such as in electric vehicles. Battery packs electrically connect a plurality of battery cells to produce a specified power output, cool the battery cells that increase in temperature during operation, and have various safety devices to respond to emergencies such as ignition, etc.

Increasing the energy density per unit volume is a major challenge for battery packs, which in turn comes down to how efficiently the space inside the battery pack can be utilized. This means more battery cells need to be able to mount into the same pack space, and making the structure of the battery pack as simple as possible is a valid way to do this.

In addition, it is advantageous to simplify the structure of the battery pack in order to reduce the production cost of the battery pack, and it is also necessary to design a structure that can be easily expanded to battery packs of various capacities.

### SUMMARY

### Technical Problem

The present disclosure is directed to provide a battery block that can simplify the structure of a battery pack to improve space utilization and reduce production costs, and that can be easily expanded to various specifications to match the capacity of the battery pack.

However, the technical problem to be solved by the present disclosure is not limited to the above-described problem, and other problems not mentioned can be clearly understood by a person skilled in the art from the description of the disclosure described below.

### Technical Solution

The present disclosure relates to a battery block, characterized in one example by including a cell array comprising a plurality of prismatic cells arranged in a row; a pair of side plates disposed on two sides of the cell array, respectively; and a pair of end plates disposed on a front surface and rear surface of the cell array, respectively, wherein both ends of the end plates in a wide direction both end plates are fixed against side brackets provided at both ends of the side plates in a length direction, and the interconnection of the end plates and the side plates constrains the cell array into one block.

In one aspect of the present disclosure, the side plates may comprise a single plate bent in an “U” shape with an open top to form a space therein.

Further, the side plate may comprise concave surfaces on both sides of the bent plate and may be provided at least one bonding rib formed by mutually bonding the concave surfaces facing each other along the length direction.

Also, the top of the side plate may have a bent upper flange that contacts a top surface of the cell array.

In one aspect of the present disclosure, the side bracket may comprise a coupling groove into which a welding bolt protruding from the end plate is inserted, and the welding bolt and the coupling groove may be interconnected by welding.

The welding bolts and the coupling grooves may be provided in pairs up and down, with reference to the center in the height direction of the cell array.

According to one aspect of the present disclosure, the side bracket may be provided with the coupling grooves on both the left and right sides with reference to the center in the width direction of the side plate.

Accordingly, another cell array arranged along the width direction may share the side plate, and a plurality of cell arrays may extend along the width direction by fixing welding bolts provided in a pair of end plates disposed at the front surface and rear surface of the another cell array, respectively, with respect to the coupling grooves of the side bracket.

Further, the end plate may include an end bracket that is fixed to the pack case.

In addition, the side bracket may comprise an end bracket fixed to the pack case.

Wherein, the end bracket may comprise a coupling portion parallel to the width direction, and the coupling surface may comprise one or more coupling holes formed therethrough.

Also, the end bracket may comprise a reinforcing rib perpendicular to the coupling portion.

### Advantageous Effects

The battery block of the present disclosure having the configuration as described above has a simple structure in which the end plates, which are joined through side brackets provided on the side plates, constrain the front, rear and sides of a cell array of a plurality of prismatic cells into a single block. Thus, by simplifying the structure of the battery block, the space utilization rate of the battery pack can be improved, and the production cost can be reduced.

Further, the battery block of the present disclosure is lightweight and exhibits excellent mechanical strength as the side plates are made of a single plate bent in an “U” shape, and the side plates of such a battery block replace the configuration of cross beams in conventional battery packs. In such a way, a battery pack with the battery block of the present disclosure can further increase the energy density in the same volume due to the elimination of the cross beam structure.

Moreover, since the battery block of the present disclosure has a structure in which a plurality of battery blocks is connected such that neighboring cell arrays share a single side plate, the total number of side plates only needs to be one more than the number of cell arrays, further improving the space efficiency of a battery pack mounting the battery block of the present disclosure.

However, the technical effects that can be obtained through the present disclosure is not limited to the above-described effects, and other effects not mentioned can be clearly understood by a person skilled in the art from the description of the disclosure described below.

### BRIEF DESCRIPTION OF THE DRAWINGS

Because the following drawings attached to the present specification illustrate exemplary aspects of the present disclosure and serve to facilitate understanding of the technical idea of the present disclosure together with the detailed description of the disclosure described below, the present disclosure should not be limitedly interpreted on the basis of the drawings.

FIG. 1 is a drawing illustrating a battery block according to one aspect of the present disclosure.

FIG. 2 is an exploded perspective view of the battery block of FIG. 1.

FIG. 3 is a drawing illustrating a side plate.

FIG. 4 is a cross-sectional view through an incision along line “A-A” of FIG. 3.

FIG. 5 is an enlarged view of the coupling structure between the side plate and the end plate.

FIG. 6 is a drawing illustrating a battery block according to another aspect of the present disclosure.

FIG. 7 is a drawing illustrating a structure in which the battery block of FIG. 1 extends in the width direction.

FIGS. 8 and 9 illustrate an exemplary structure for securing the battery block of the present disclosure to a pack case.

### DETAILED DESCRIPTION

The present disclosure may have various modifications and various aspects, and thus specific aspects thereof will be described in detail below.

However, it should be understood that the present disclosure is not limited to the specific aspects, and includes all modifications, equivalents, or alternatives within the spirit and technical scope of the present disclosure.

The terms “comprise,” “include,” and “have” used herein designate the presence of characteristics, numbers, steps, actions, components, or members described in the specification or a combination thereof, and it should be understood that the possibility of the presence or addition of one or more other characteristics, numbers, steps, actions, components, members, or a combination thereof is not excluded in advance.

In addition, in the present disclosure, when a part of a layer, film, region, plate, or the like is disposed “on” another part, this includes not only a case in which one part is disposed “directly on” another part, but a case in which still another part is interposed therebetween. In contrast, when a part of a layer, film, region, plate, or the like is disposed “under” another part, this includes not only a case in which one part is disposed “directly under” another part, but a case in which still another part is interposed therebetween. In addition, in the present application, “on” may include not only a case of being disposed on an upper portion but also a case of being disposed on a lower portion.

The present disclosure relates to a battery block, which, in one example, includes a cell array comprising a plurality of prismatic cells arranged in a row; a pair of side plates disposed on both sides of the cell array, respectively; and a pair of end plates disposed on the front and rear surfaces of the cell array, respectively.

The both ends of the end plates in a width direction are fixed against side brackets provided at both ends of the side plates in a length direction, and by such interconnection of the end plates and the side plates, the cell array is constrained as a block.

Further, the side plate may comprise a single plate bent in the form of an “U” with an open top to form a space therein.

The battery block of the present disclosure with the configuration as described above has a simple structure in which the end plates, which are joined through side brackets provided on the side plates, constrain the front, rear and sides of a cell array of a plurality of prismatic cells into a single block. Thus, by simplifying the structure of the battery block, the space utilization rate of the battery pack can be improved, and the production cost can be reduced.

In addition, the battery block of the present disclosure is lightweight and exhibits excellent mechanical strength as the side plates are made of a single plate bent into an “U” shape, and the side plates of the battery block replace the configuration of cross beams in conventional battery packs. As such, battery packs with the battery block of the present disclosure will be able to further increase the energy density in the same volume due to the elimination of the cross-beam structure.

Hereinafter, specific aspects of a secondary battery of the present disclosure will be described in detail with reference to the accompanying drawings.For reference, the directions of front, back, up, down, left, and right used in the following description to designate relative positions are for the purpose of understanding the disclosure and refer to the directions shown in the drawings unless otherwise specified.

### First Aspect

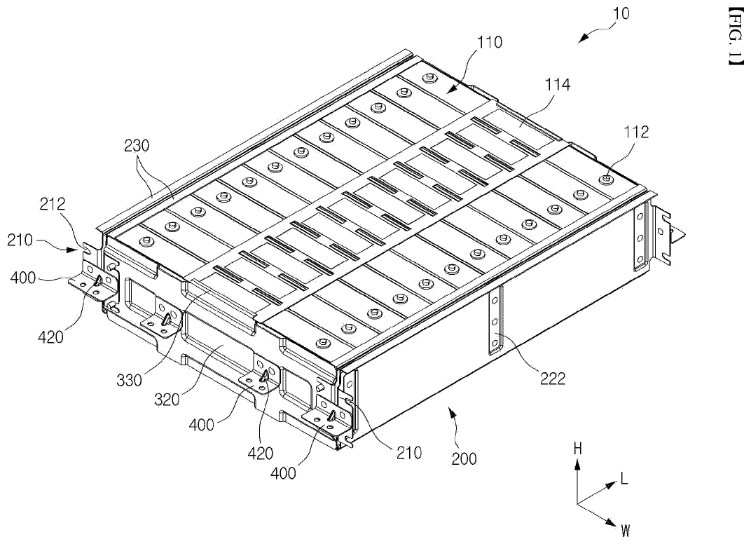

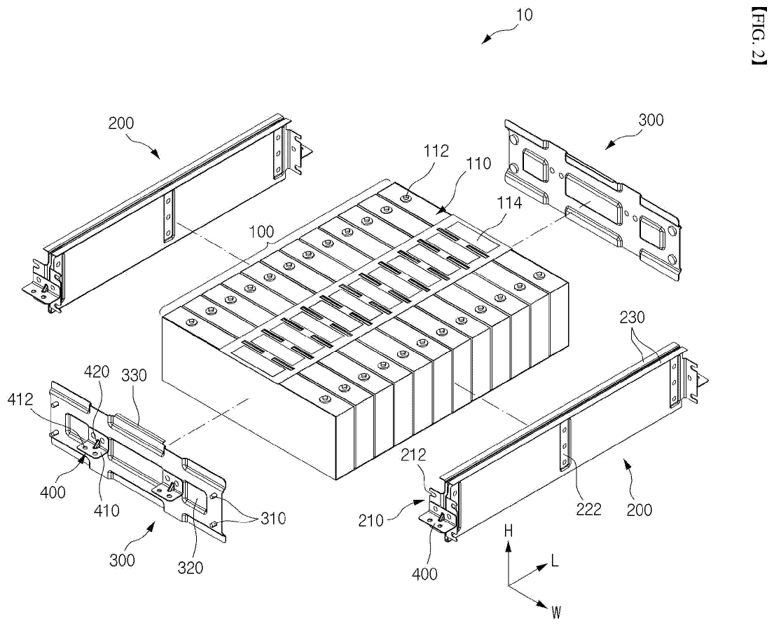

FIG. 1 is a drawing illustrating a battery block according to one aspect of the present disclosure. FIG. 2 is an exploded perspective view of the battery block of FIG. 1.

Referring to the attached FIGS. 1 and 2, a battery block 10 of the present disclosure includes a pair of side plates 200 and a pair of end plates 300 that are joined thereto to form a parallelepiped-shaped space, and a cell array 100 accommodated in the parallelepiped space.

The cell array 100 refers to one group of cells comprising a plurality of prismatic cells 110 arranged in a row. Each prismatic cell 110 is a finished prismatic secondary battery capable of charging and discharging independently, and in the aspect shown, 12 prismatic cells 110 are shown together to form a single cell array 100. All of the prismatic cells 110 are typically constructed to the same specifications, and the prismatic cells 110 aligned in a row have the overall shape of a parallelepiped.

For reference, the illustrated prismatic cell 110 corresponds to a unidirectional prismatic cell 110 having both positive and negative electrode terminals 112 disposed on the upper surface, and also having a venting device 114 between the pair of electrode terminals 112. The venting device 114 is a safety valve that ruptures to relieve the pressure inside the prismatic cell 110 when an exceedingly high level of pressure is applied, and may comprise, for example, a notched rupture disk made of a thin plate-like member of a metal material. When the pressure inside the enclosed prismatic cell 110 rises, the pressure causes tensile deformation across the thin plate and tears the less strong notch portions, releasing the pressure inside the prismatic cell 110.

Further, the electrode terminals 112 of the prismatic cells 110 on the cell array 100 may be arranged to have the same polarity in a series of rows or alternating opposite polarities to facilitate electrical connections in parallel or series. In other words, alignment of the plurality of prismatic cells 110 in a row does not necessarily mean alignment of the polarity of the electrode terminals 112 in a row.

A pair of side plates 200 are disposed on two sides of the cell array 100, respectively, and a pair of end plates 300 are disposed on the front and rear surfaces of the cell array 100, respectively. Both ends of the end plates 300 in the width direction (W) are fixed against side brackets 210 provided at both ends of the side plates 200 in a length direction (L), and the interconnection of the end plates 300 and the side plates 200 constrains the cell array 100 as one block.

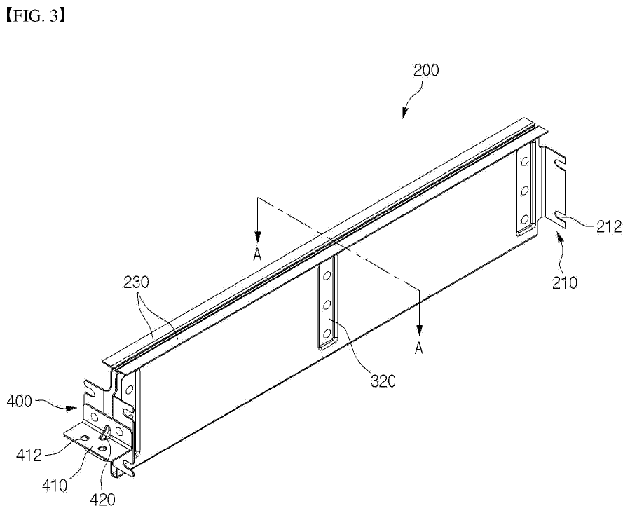

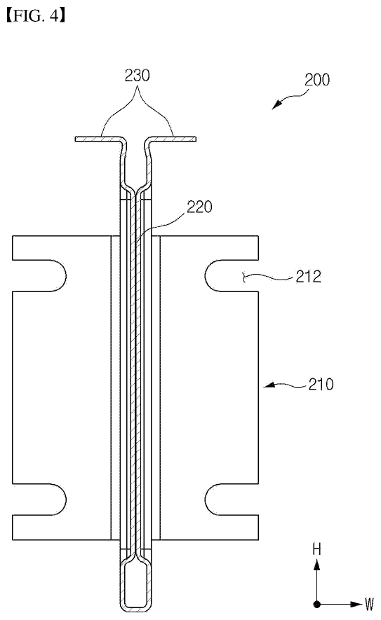

FIG. 3 is a drawing illustrating side plate 200, and FIG. 4 is a cross-sectional view through an incision along line “A-A” in FIG. 3. The illustrated side plate 200 comprises a single plate bent into an “U” shape with an open top to form a space within. By bending a single plate into an “U” shape with an open top, the side plate 200 is lightweight and exhibits excellent mechanical strength.

In addition, as shown in FIGS. 3 and 4, the side plate 200 has concave surfaces 222 on both sides of the bent plate, and the facing concave surfaces 222 are interjoined to form bonding ribs 220. These bonding ribs 220 are provided at least one along the length direction L of the side plate 200, and in the aspect shown, a total of three bonding ribs 220 are formed at both ends and in the center of the side plate 200.

A single plate bent in an “U” shape may have excellent durability and strength against compression and tension in the length direction L due to the bending structure, but may be relatively weak against forces in the height direction (H). The bonding ribs 220 improve the stiffness of the side plate 200 against the height direction (H) force by connecting the concave surface 222 and the concave surface 222 on both sides of the side plate 200 by welding, riveting, or the like.

By such a structure of the side plate 200, namely, a single plate structure bent in the form of an “U” and a structure of concave surface 222 interconnected with each other, the side plate 200 has a light weight and strong mechanical strength. Accordingly, in the battery block 10 of the present disclosure, the side plate 200 replaces the configuration of the cross beam conventionally provided in the battery pack, and the simplified structure of the battery pack enables the space utilization rate of the battery pack to be improved, further increasing the energy density in the same volume, and reducing the production cost.

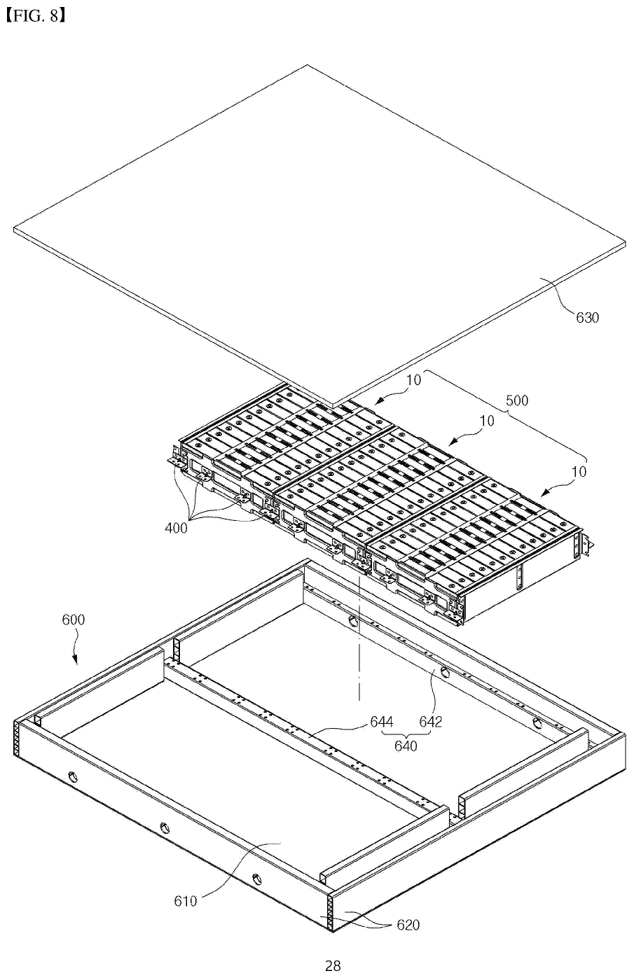

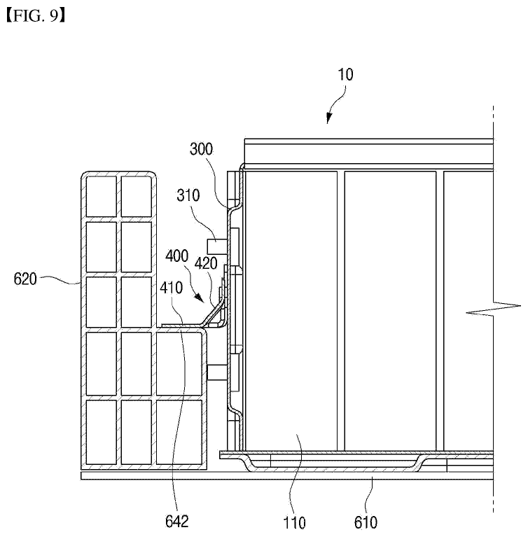

Further, the top of the side plate 200 is formed with a bent upper flange 230 that contacts the top surface of the cell array 100. The upper flange 230 creates a downward fixation force that presses the cell array 100 to the bottom when the battery block 10 is installed in the pack case 600. The structure by which the battery block 10 of the present disclosure is installed in the pack case 600 will be described in more detail later with reference to FIGS. 8 and 9.

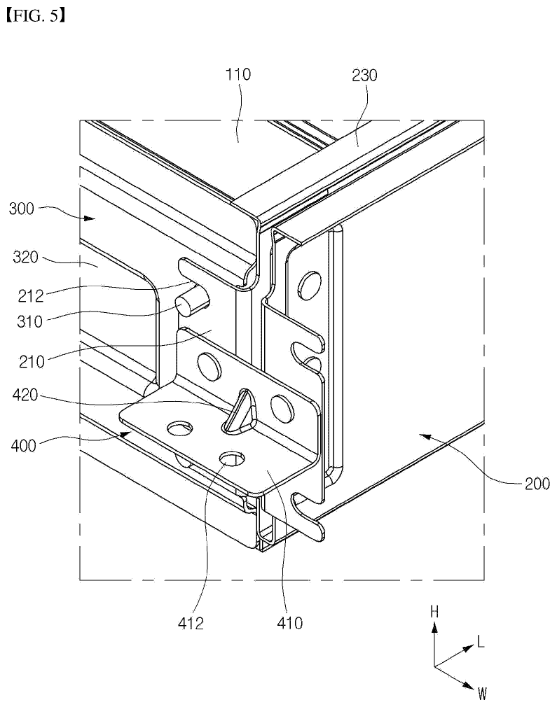

FIG. 5 is an enlarged view of the coupling structure between the side plate 200 and the end plate 300. A side bracket 210 provided on the side plate 200 has a coupling groove 212 into which a welding bolt 310 protruding from the end plate 300 is inserted, and the welding bolt 310 and the coupling groove 212 are joined to each other by welding.

Welding bolts 310 provided on a pair of end plates 300 disposed on the front and rear of the cell array 100, respectively, provide a coupling point for the side brackets 210, and coupling grooves 212 are engaged in the welding bolts 310 to assume the assembly position of the side plates 200 and end plates 300. For a stable and robust connection of the side plate 200 and the end plate 300, and for strong constraint to the cell array 100, the welding bolts 310 and the coupling grooves 212 may be provided in an up-down pair with respect to the center of the height direction H of the cell array 100.

Further, referring to FIGS. 1 to 3 and 5, the end plate 300 includes an end bracket 400 that is fixed to the pack case 600. Additionally, the side bracket 210 also includes end bracket 400 that is fixed to the pack case 600.

The end bracket 400 provided on the end plate 300 and the side plate 200 has a coupling portion 410 parallel to the width direction W, and one or more coupling holes 412 are formed through the coupling portion 410 of the end bracket 400. The coupling portion 410 of the end bracket 400 engages a mounting portion 640 provided in the pack case 600 (see FIG. 9), and the battery block 10 is fixed to the pack case 600 by joining or binding the end bracket 400 to the mounting portion 640 of the pack case 600 through the coupling holes 412.

Further, the end bracket 400 may include reinforcing ribs 420, such as in the form of a right triangle perpendicular to the coupling portion 410, to provide additional strength to height direction H loading. Additionally, one or more concave surfaces 320, similar to the concave surfaces 222 of the side plates 200, may be bent and formed to reinforce the rigidity of the end plate 300 itself, and the top of the end plate 300 may also be provided with an upper flange 330 for stable fixation of the cell array 100.

As such, the battery block 10 of the present disclosure has a simple structure in which the end plates 300, which are coupled through side brackets 210 provided on the side plates 200, constrain the front and rear and sides of the cell array 100 comprising a plurality of prismatic cells 110 as a single block. Thus, the simplified structure of the battery block 10 can improve the space utilization of the battery pack and reduce production costs.

In addition, the battery block 10 of the present disclosure is lightweight and exhibits good mechanical strength as the side plates 200 are made of a single plate bent in an “U” shape, and the side plates 200 of the battery block 10 replace the configuration of cross beams conventionally provided in battery packs.

### Second Aspect

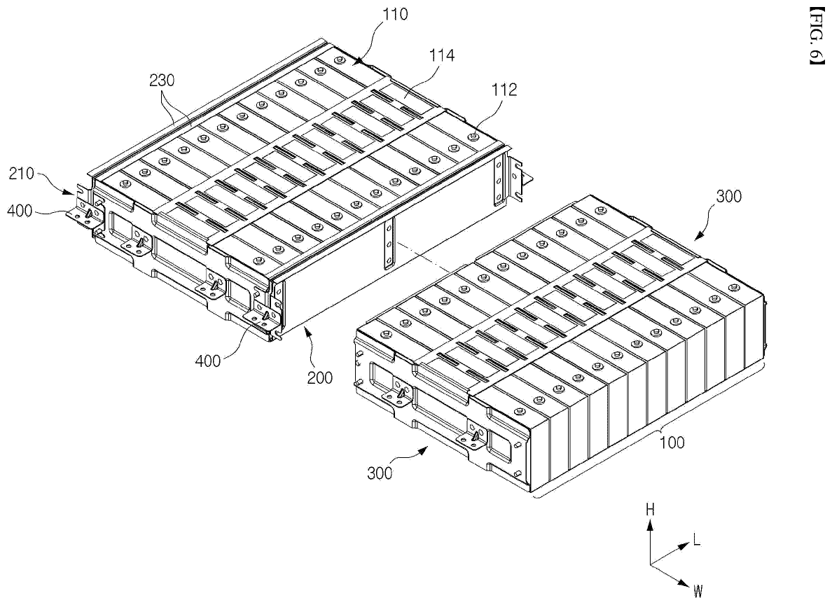

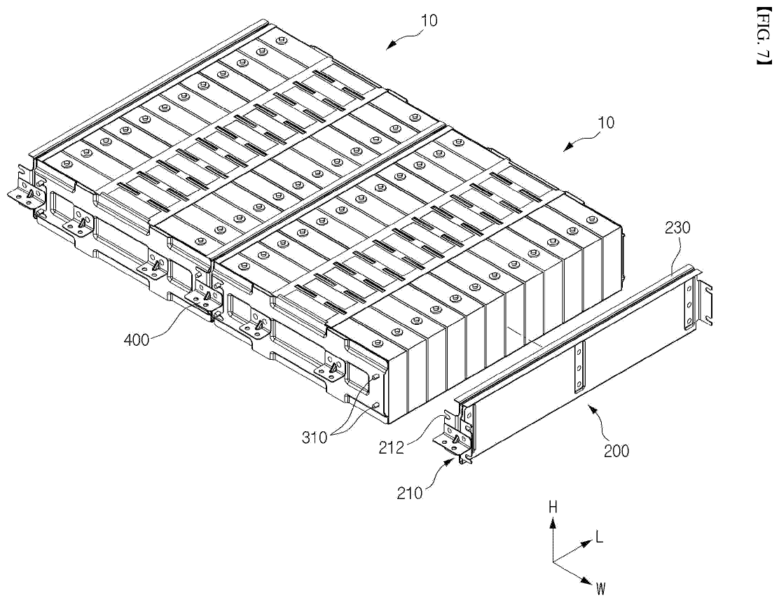

FIG. 6 is a drawing of a battery block 10 according to another aspect of the present disclosure, and FIG. 7 is a drawing of a structure in which the battery block 10 of FIG. 4 extends in the width direction W.

The battery block 10 of the present disclosure is expandable by any number of cell arrays 100 along the width direction W through the side plates 200 and side brackets 210. A second aspect of the present disclosure describes an aspect of such expansion of the battery block 10.

Referring to FIG. 6, the side brackets 210 are provided with coupling grooves 212 on each of the left and right sides with respect to the center of the width direction W of the side plates 200. Thus, for one side plate 200, it is possible to connect one end plate 300 on each side of the width direction W thereof.

As shown in FIG. 7, another cell array 100 arranged along the width direction W shares a single side plate 200 in the center, and a plurality of cell arrays 100 may extend along the width direction W by means of welding bolts 310 provided in a pair of end plates 300 disposed at the front surface and rear surface of the other cell array 100, respectively, being fixed against coupling grooves 212 in the side brackets 210.

In this way, as the side brackets 210 are provided with coupling grooves 212 on both the left and right sides, respectively, one end plate 300 can be combined with each side of one side plate 200, and as adjacent cell arrays 100 share one side plate 200, the total number of side plates 200 in a structure in which a plurality of battery blocks 10 are connected requires only one more than the number of cell arrays 100. Thus, the space efficiency of a battery pack carrying the battery blocks 10 of the present disclosure is further improved.

Further, FIGS. 8 and 9 are exemplary drawings illustrating a structure for fixing a battery block 10 of the present disclosure to a pack case 600.

The pack case 600 in which the plurality of battery blocks 10 are installed includes a base plate 610 forming a bottom surface, side frames 620 forming walls along all sides of the base plate 610, and a top cover 630 enclosing the top surface of the pack case 600. The pack case 600 shown illustrates an example of two battery modules 500 with side plates 200 and end plates 300 joined together in a grid configuration to form a row of three cell arrays 100 (one assembly of a plurality of connected battery blocks according to a first aspect will be referred to herein as a battery module).

One battery module 500, in which the three cell arrays 100 are aligned in a row, has end brackets 400 exposed along the end plates 300 at the front and rear, and one end bracket 400 also exposed on the side brackets 210 between the end plates 300.

Referring to the cross-sectional view of FIG. 9, the pack case 600 is provided with rail-shaped mounting portions 640 corresponding to the coupling portions 410 of the end brackets 400 that project to the front and rear of the battery module 500. The mounting portion 640 includes a pair of side mounting portions 642 coupled to or integrally formed with the side frame 620, and a center mounting portion 644 arranged across the center of the base plate 610.

When the battery modules 500 are inserted into the space between the side mounting portions 642 and the center mounting portions 644, the coupling portions 410 of the end brackets 400 extend along and face the mounting portions 640 of the pack case 600, and all of the battery blocks 10 are fixed to the pack case 600 by joining or binding the end brackets 400 to the mounting portions 640 of the pack case 600 through the coupling holes 412.

Here, when the end brackets 400 of each battery block 10 are engaged and fixed to the mounting portions 640 of the pack case 600, the side plates 200, and by extension, the upper flanges 230, 330, which are bent and formed on the top of the end plates 300, automatically generate a downward fixation force that presses the cell array 100 against the base plate 610, thereby ensuring that the cell array 100 is firmly pressed to the base plate 610.

The contact between the cell array 100 and the base plate 610 plays an important role in facilitating the transfer of heat generated by the cell array 100 to the base plate 610. Therefore, it would be advantageous for the upper flanges 230, 330 to generate sufficient downward fixation force if the tolerances are managed in such a way that there is a small amount of gap between the coupling portion 410 of the end bracket 400 and the mounting portion 640 when the battery block 10, or battery module 500, is placed in the pack case 600.

As above, the present disclosure has been described in more detail through the drawings and aspects. However, since the configuration described in the drawings or aspects described herein is merely one aspect of the present disclosure and do not represent the overall technical spirit of the disclosure, it should be understood that the disclosure covers various equivalents, modifications, and substitutions at the time of filing of this application.

### Description of Reference Numerals

10: battery block
100: cell array
110: prismatic cell
112: electrode terminal
114: venting device
200: side plate
210: side bracket
212: coupling groove
220: bonding rib
222: concave surface
230: upper flange
300: end plate
310: welding bolt
320: concave surface
330: upper flange
400: end bracket
410: coupling portion
412: coupling hole
420: reinforcing rib
500: battery module
600: pack case
610: base plate
620: side frame
630: upper cover
640: mounting portion
642: side mounting portion
644: center mounting portion
W: width direction
L: length direction
H: height direction

1. A battery block, comprising:
a cell array comprising a plurality of prismatic cells arranged in a row;
a pair of side plates disposed on two sides of the cell array, respectively, and along a length direction of the cell array; and
a pair of end plates disposed on a front surface and rear surface of the cell array, respectively, and along a width direction of the cell array,
wherein both ends of each end plate of the pair of end plates are fixed against side brackets disposed at both ends of each side plate of the pair of side plates, respectively, such that the pair of end plates and the pair of side plates are interconnected and configured to constrain the cell array into one block.

2. The battery block of claim 1, wherein each side plate of the pair of side plates comprises a single bent plate having a “U” shape including an open top defining a space therein.

3. The battery block of claim 2, wherein each side plate of the pair of side plates comprises concave surfaces on both sides of the single bent plate, the concave surfaces being bonded together to define at least one bonding rib, and wherein the concave surfaces face each other along the length direction.

4. The battery block of claim 2, wherein each side plate of the pair of side plates has a bent upper flange that is configured to contact a top surface of the cell array.

5. The battery block of claim 1, wherein each bracket of the side brackets comprises a coupling groove that is configured to receive a welding bolt protruding from a respective end plate of the pair of end plates, and wherein each of the welding bolts and each of the respective coupling grooves are welded together.

6. The battery block of claim 5, wherein the welding bolt protruding from each end plate is disposed in a pair of welding bolts along a height direction of the cell array, and the coupling groove of each bracket is disposed in a pair of coupling grooves along the height direction of the cell array such that a center of the cell array along the height direction is positioned between the pair of welding bolts and the pair of coupling grooves.

7. The battery block of claim 5, wherein the coupling grooves are disposed in a first pair of coupling grooves and a second pair of coupling grooves that are positioned on opposite sides of each of the side brackets with a center of a first side plate of the pair side plates along the width direction disposed therebetween.

8. The battery block of claim 7, further comprising a second cell array disposed adjacent to the first side plate of the pair of side plates, the second cell array including a plurality of cell arrays extend along the length direction and configured for fixing second welding bolts extending from a pair of second end plates disposed at a front surface and a rear surface of the second cell array, respectively, to the coupling grooves of the side brackets.

9. The battery block of claim 8, wherein a first end plate of the pair of end plates comprises an end bracket that is fixed to a pack case.

10. The battery block of claim 9, wherein at least one of the side brackets comprises the end bracket fixed to the pack case.

11. The battery block of claim 9, wherein the end bracket comprises a coupling portion extending parallel to the width direction, and the coupling portion comprises one or more coupling holes disposed therethrough.

12. The battery block of claim 11, wherein the end bracket comprises a reinforcing rib extending from the coupling portion.

13. The battery block of claim 10, wherein the end bracket comprises a coupling portion extending parallel to the width direction, and the coupling portion comprises one or more coupling holes disposed therethrough.

14. The battery block of claim 13, wherein the end bracket comprises a reinforcing rib extending from the coupling portion.
